(19) United States
(12) Patent Application Publication
(10) Pub. No.: US 2006/0237109 A1
(43) Pub. Date: Oct. 26, 2006

(54) Holding device for fixing an electronic component

(76) Inventors: Anton Mangold, Garmisch-Partenkirchen (DE); Josef Schorer, Eschenlohe (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 10/536,453

(22) PCT Filed: Nov. 17, 2003
(86) PCT No.: PCT/EP03/12864

§ 371 Date: May 19, 2006

(51) Int. Cl. B60C 23/04

(52) U.S. Cl. 152/152.1; 340/442

(57) ABSTRACT

The invention relates to a holding device for a fixing an electronic component in a wheel. The holding device comprises at least one device carrier (5) for receiving and holding electronic components (6) and also comprises at least one at least partially elastic damper foot (7) which is permanently flexibly connected to the tire covering (1). The damper foot (7) has a dampening effect and is configured in such a way that it is elastic and tapered along the longitudinal axis thereof. The damper foot (7) can be fixed to the device carrier (5) and the tire covering (1) by adhesion or vulcanization, for example. In other embodiments, the damper foot (7) is also produced with the device carrier and the tire covering in a single piece made of tire material. Preferably, the damper foot can conduct heat and energy and contains a capacitive or inductive coupling for connecting two electronic components (6) or an antenna.

The invention relates to a holding device for fixing an electronic component in a wheel containing a tire. Such holding devices are used for fixing, for example, sensors monitoring the tire filling pressure, the tire temperature or the profile depth of vehicle or aircraft tires, or also for fixing transponders, which then transfer such characteristic values to on-board vehicle computers for further evaluation. Holding devices, which fix the corresponding electronic components to the tire valve or to the rim inside the wheel, are known from prior art.

However, the disadvantage of these known holding devices for fixing electronic components is that they do not enable a free selection of the fixing location of the electronic components. Also, the electronic component cannot be fixed directly on the tire covering using these known holding devices. Thus it is not possible to determine measured variables such as, for example, the tire temperature using a sensor directly on the most stressed location where these measured variables develop, such as the tread in this case. This inevitably leads to falsified measurement results.

Furthermore, electronic components held in such a manner must be fixed, e.g. on the rim in an additional installation step. This leads to additional installation costs and additional possible sources of error when fixing the electronic component on the wheel. However, defective or wrongly installed holding devices used, for example, for fixing a sensor on the valve inside the tire interior, pose a great hazard. Should the electronic component become loose due to being fixed incorrectly, it would lead to tire blowouts as a rule. Fixing these relatively heavy components on the valves can also lead to leakages of the valves or of the seals between the valve and the tire.

An additional disadvantage of the known holding devices is that a distinct classification of tire-specific sizes is not possible.

Therefore, the object of the invention is to create a holding device for fixing an electronic component in a wheel wherein said holding device enables an accurate determination of measured values on the tire.

This object is achieved according to the invention by a holding device for fixing an electronic component in a wheel containing a tire covering, said holding device comprising at least one device carrier for receiving and holding the electronic component and at least one at least partially elastic damper foot, which is permanently flexibly connected to the tire covering.

The permanently flexible connection of the holding device to the tire covering enables an almost freely selectable fixing position on the tire covering. The term “permanently flexible connection” refers to a connection, which enables a persistently safe, flexible, elastic connection over the duration of the tire even under the effect of strong vibrations and temperature fluctuations.

The term “tire covering” here includes those tire parts, which encase the tire interior in the broadest sense. The holding device can thereby be fixed both on the tread as well as on the lateral wall of the tire. The holding device can thereby be fixed directly on the inlying surface of the tire covering or even in a layer of the tire covering, said layer being located further on the inside, e.g. the inner liner, a butyl layer that counteracts the air diffusion through the tire.

The device carrier is used for receiving and fixing the electronic components in the holding device. The device carrier can thus be e.g. a shell-shaped or U-shaped component, into which the electrical components can be inserted and then fixed there. A plate, on which the electronic components can be fixed, would also be feasible.

The damper foot is used for the mechanical decoupling of the device carrier and the electrical components located therein from the movements, deformations and vibrations of the tire covering. These movements, deformations and vibrations are thus transferred onto the device carrier only in an absorbed and/or dampened form. This leads to a distinct reduction in the mechanical load of the electronic components, increases inter alia their operational reliability, and thus enables the holding device to be fixed in those regions of the tire, which are stressed particularly strongly, e.g. due to flexing work. Thus a high degree of flexibility in the arrangement of the electrical components is also achieved. Due to this, e.g. sensors or transponders can also be arranged in tires having emergency running properties. An adherence to the running direction could also be prevented by the central arrangement of the holding device directly below the tread of the tire.

The damper foot can be embodied to be partially elastic, e.g. as a rigid metal pipe or plastic pipe having a spring element or a damper element, or it can also be completely elastic, e.g. a pipe made of rubber, natural rubber or elastic plastic. The shape of the damper foot can be inter alia e.g. mushroom-shaped, quadratic, cuboid, prismatic, conical or cylindrical.

The thus ensured permanent fixing on the tire of e.g. electronic components, which store characteristic values or are also rewritable and can be fixed when the tires are manufactured, enables an individualization of the tire. Thus security-relevant information about the tire can be input to the electronic component, e.g. an RFID transponder. Such characteristic values include, for example, the load and speed indices, the tire type or the manufacturing date and the serial number of the tire. The rewritability is of particular interest inter alia during the retreading of tires. It is thus possible to keep records, for example, of the load history of the tire, wherein such records, as a load collective diagram in turn allow inferences to be drawn about the state of the tire.

In a preferred improved configuration of the holding device, the damper foot is manufactured from the same elastic material as the tire covering. This prevents the occurrences of different temperature expansions and corresponding restraint stresses between the holder and the tire, wherein said temperature expansions and restraint stresses negatively influence the durability of the permanently flexible connection.

In another improved configuration of the holding device, the damper foot is embodied to be at least partially hollow. Thus, it can be e.g. tubular or can comprise weight-reducing and damping-reinforcing hollow spaces, chambers or honeycombs. A continuously hollow embodiment is also feasible.

In order to enable the temperature measurement using a sensor located in the device carrier, the damper foot in one embodiment can at least partially contain a heat conducting material. Thus e.g. the hollow space of the tubular damper foot could be filled with such a heat conducting material. However, the entire damper foot can also be embodied expediently from a material that is a good conductor of heat or to manufacture the damper foot out of a composite material, which contains e.g. copper wires or copper particles or other heat conducting materials.

In order to enable an energy transfer through the damper foot, it is additionally advantageous if the damper foot at least partially contains an electricity conducting material. However, it is also expedient to embody the entire damper foot from a material that is a good conductor of electricity or to manufacture the damper foot from a composite material, which contains e.g. copper wires or copper particles or other electricity conducting materials.

In another preferred embodiment, the damper foot could contain an antenna. This antenna could be integrated both into the material of the damper foot or could also be arranged in the hollow space of the damper foot.

The damper foot is preferably embodied to be at least partially tapering in its lateral extension. Such a partial taper can be e.g. a notch. This taper leads to a reinforced mechanical decoupling of the device carrier from the tire covering and the movements of the latter.

In another preferred improved configuration of the holding device, the tire covering and the damper foot form a contiguously manufactured monolithic unit. This means, that the damper foot is manufactured out of the same metal as that of the tire and is contiguously manufactured with the latter in a single piece. Thus in this case, the damper foot would represent a type of inward elevation of the tire covering.

In another embodiment the holding device can be glued on the tire covering. This can take place, e.g. by an adhesion using an adhesive or by a cold or hot vulcanization process. It would thus be possible to retrofit the tires with the inventive holding device.

The device carrier is preferably manufactured from a metal. This could be e.g. aluminum or steel. An embodiment in which the device carrier consists of plastic such as e.g. PVC is feasible and also advantageous.

The device carrier can be fixed on the damper foot using adhesion or vulcanization. In another embodiment, the device carrier is attached to the damper foot. This attachment refers to a flexible connection e.g. using clips or a snap locks. Due to this, subsequent changes can be carried out on the electronic component or on the device carrier in that the device carrier is then attachable and detachable. This allows, e.g. a mass production of tires, which are all already provided with a damper foot. Such tires, though only marginally costlier to manufacture, would enable e.g. the tire to be subsequently equipped with an electronic component, depending on customer preferences. Due to this, it would also be possible to replace defective electrical components without having to replace the entire tire. This would also reduce the logistic expenditure when manufacturing the tires.

In another embodiment, the damper foot and the device carrier form a contiguously manufactured monolithic unit. This means that the device carrier is manufactured out of the same material as that of the damper foot and is manufactured contiguously with the damper foot in a single piece. In this case, the device carrier would represent a type of expansion of the tire covering e.g. with a location surface or a bulge.

In another embodiment of the holding device, the device carrier is fixed on the tire covering using at least one cross-member with at least one damper foot. Due to this it is possible to arrange the device carrier e.g. lateral to instead of directly above the center of gravity of the damper foot and thus to increase inter alia the mechanical decoupling of the holding device. It can also be advantageous to fix several electronic components with one holding device on the tire, said electronic components being arranged at a distance from one another, wherein a bigger device carrier would be fixed on this cross-member and the cross-member would be loaded with several damper feet. A bridge-like embodiment in which the cross-member connects at least two damper feet and the device carrier is seated on the cross-member is advantageous. Such a cross-member could consist of e.g. a plastic rail or metal rail or even the same material as that of the damper foot.

The electronic components to be held are preferably fixedly connected to the device carrier. This can also take place by adhesion and/or vulcanization to the device carrier.

In another embodiment, a capacitive or inductive coupling for connecting two electronic components is provided. This makes it possible to combine the advantages of the present invention with those of the patent application of the inductive and/or capacitive coupling for connecting two electronic components, said application being filed by the inventor in parallel to this invention.

In the following description, the invention is explained further on the basis of embodiments illustrated in the drawing, of which:

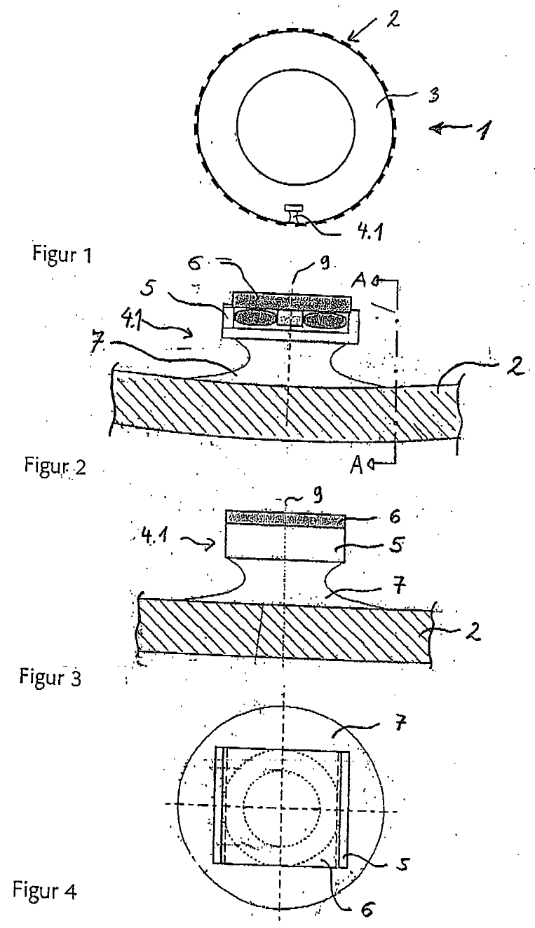

FIG. 1 schematically illustrates a section of a tire in which a holding device for fixing electronic components is attached on the tread;

FIG. 2 schematically illustrates an enlarged cross-sectional view of the holding device shown in FIG. 1;

FIG. 3 schematically illustrates a lateral view A-A of the holding device shown in FIG. 2;

FIG. 4 schematically illustrates a top view of the holding device shown in FIGS. 1, 2, and 3;

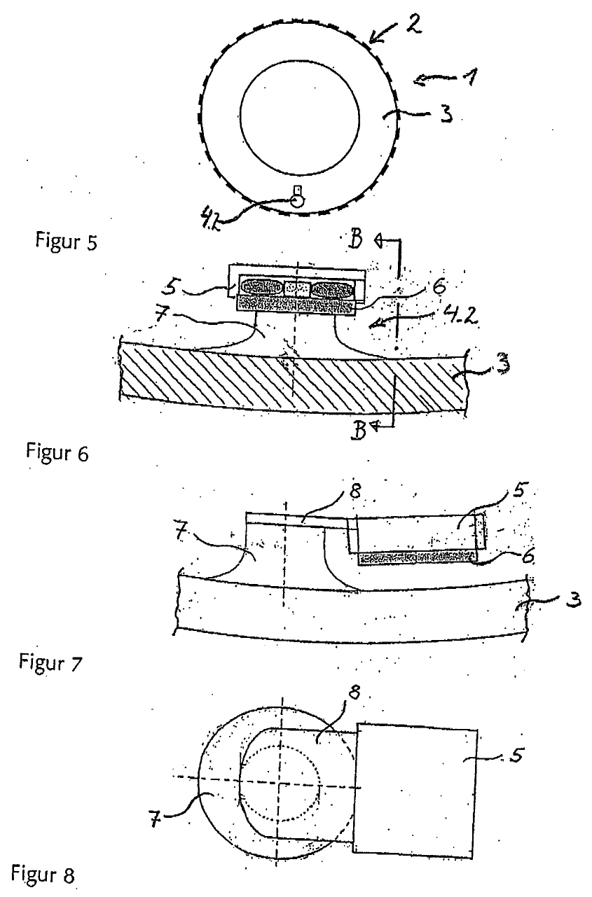

FIG. 5 schematically illustrates a section of a tire in which a holding device for fixing electronic components is attached on the lateral wall of the tire and in which the device carrier is fixed laterally on a cross-member;

FIG. 6 schematically illustrates an enlarged cross-sectional view of the holding device shown in FIG. 5;

FIG. 7 schematically illustrates the lateral view B-B of the holding device shown in FIG. 6;

FIG. 8 schematically illustrates a top view of the holding device shown in FIGS. 5, 6, and 7;

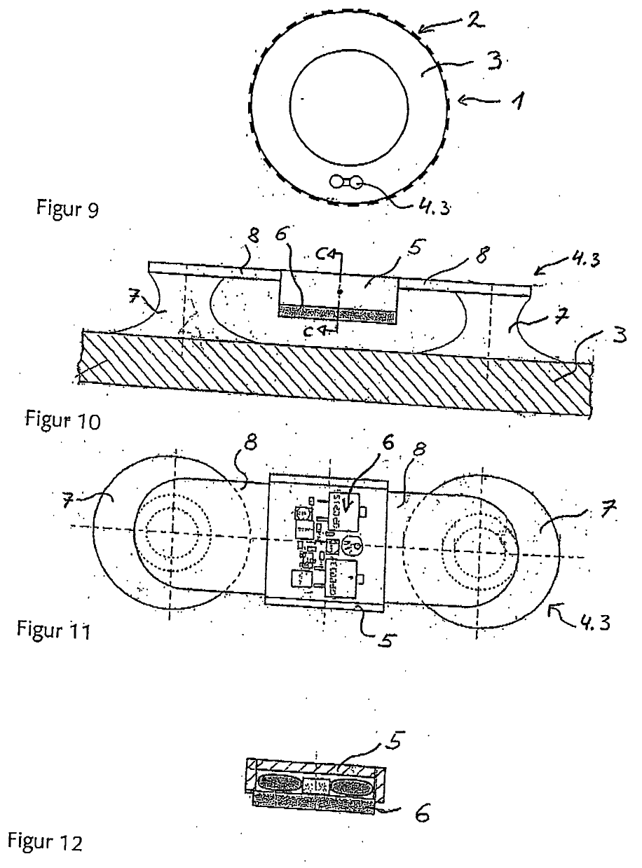

FIG. 9 schematically illustrates a section of a tire in which a holding device for fixing electronic components is attached on the lateral wall of the tire and in which the device carrier is held laterally by two cross-members loaded with damper feet;

FIG. 10 schematically illustrates a lateral view of the holding device shown in FIG. 9;

FIG. 11 schematically illustrates a top view of the holding device shown in FIG. 10; and

FIG. 12 schematically illustrates the section C-C of the holding device shown in FIGS. 9, 10, and 11.

Like parts are provided with like reference numerals in the figures.

Describing the figures now in detail, FIG. 1 illustrates a section of a tire 1, which comprises a lateral wall 3 and a tread 2. In the tire 1, a first embodiment 4.1 of a holding device for fixing electronic components, such as e.g. sensors, transponders or storage media is attached on the interior of the tread 2.

As illustrated in FIG. 2 and FIG. 3, the holding device 4.1 illustrated in FIG. 1 contains a single damper foot 7 and a device carrier 5. An electronic component 6 is thereby fixed on the device carrier 5. In this embodiment, the damper foot 7 is a rotation-symmetrically formed component, which tapers along its longitudinal axis 9. In this embodiment, the damper foot 7 is permanently flexibly connected to the tread 2 and the device carrier 5. In this embodiment, the device carrier 5 is embodied to be U-shaped and can consist, for example, of metal or plastic material.

FIG. 4 illustrates a top view of the holding device 4.1 shown in FIG. 2 and FIG. 3. In this first embodiment, the damper foot 7 has a perfectly cylindrical cross-section. The thickness of the damper foot 7 is the largest in the region where the damper foot is fixed on the tread; the thickness of the damper foot is the lowest in the region of its center and again increases towards the region where the device carrier 5 is fixed. Due to this embodiment, the damper foot has the largest possible joint surface in the region where it is fixed to the tire covering, here the inside of the tread 2 and the device carrier 5. Due to this, the largest possible joint force is attained between the damper foot 7 and the tire 1 and/or the device carrier 5. The taper in the center region in turn creates an especially good mechanical decoupling from the vibrations and the movements of the tire 1.

FIG. 5 illustrates a section of a tire 1, in which a holding device for fixing electronic components according to a second embodiment is shown. Here, the holding device 4.2 is attached to the lateral wall 3 of the tire 1.

FIG. 6 illustrates an enlarged cross-sectional view of the holding device 4.2 shown in FIG. 5. In this illustration, an electronic component 6 is inserted from below into the device carrier 5. The damper foot 7 comprises a broadened fixing surface in the region of the tire lateral wall 3 and tapers towards the cross-member 8, as can be seen in FIG. 7. The device carrier 5 is thereby fixed laterally on the cross-member 8. The cross-member 8 is in turn permanently flexibly fixed to the damper foot 7. The connection between the damper foot 7 and the tire wall 3 is also permanently flexible. In this embodiment, the electronic component 6 is fixed on the side of the device carrier 5, said side being turned towards the tire wall 3.

FIG. 9 illustrates a section of the tire 1. Here a holding device according to a third embodiment for fixing electronic components in a tire 1 is illustrated. As can also be seen in FIG. 10, the device carrier 5 is held here by two laterally attached cross-members 8. A damper foot 7 is fixed on each of the two lateral ends of the cross-members 8. The damper feet 7 are in turn permanently flexibly connected to the tire lateral wall 3. As can be clearly seen in FIGS. 11 and 12, different electrical components 6 can be fixed in the device carrier 5.

1. Holding device for fixing an electronic component in a wheel containing a tire covering,
characterized in that
the holding device contains at least one device carrier for receiving and holding the electronic component and at least one at least partially elastic damper foot, which is permanently flexibly connected to the tire covering.

2. Holding device according to claim 1,
characterized in that
the damper foot consists of the same elastic material as the tire covering.

3. Holding device according to claim 1 or 2,
characterized in that
the damper foot is at least partially hollow.

4. Holding device according to any of the preceding claims,
characterized in that
the damper foot at least partially contains a heat conducting material.

5. Holding device according to any of the preceding claims,
characterized in that
the damper foot at least partially contains an electricity conducting material.

6. Holding device according to any of the preceding claims,
characterized in that
the damper foot contains an antenna.

7. Holding device according to any of the preceding claims,
characterized in that
the damper foot is configured such that it is tapered at least partially in its lateral extension.

8. Holding device according to any of the preceding claims,
characterized in that
the tire covering and the damper foot form a contiguously manufactured monolithic unit.

9. Holding device according to any of the claims 1 to 7,
characterized in that
the holding device is stuck on the tire covering.

10. Holding device according to any of the claims 1 to 7,
characterized in that
the holding device is vulcanized on the tire covering.

11. Holding device according to any of the preceding claims,
characterized in that
the device carrier consists of metal.

12. Holding device according to any of the claims 1 to 10,
characterized in that
the device carrier consists of plastic.

13. Holding device according to any of the preceding claims,
characterized in that
the device carrier is stuck on the damper foot.

14. Holding device according to any of the preceding claims,
characterized in that
the device carrier is vulcanized on the damper foot.

15. Holding device according to any of the claims 1 to 12,
characterized in that
the device carrier is stuck to the damper foot.

16. Holding device according to any of the claims 1 to 12,
characterized in that
the damper foot and the device carrier form a contiguously manufactured monolithic unit.

17. Holding device according to any of the preceding claims,
characterized in that
the device carrier is fixed to the tire covering using at least one cross-member with at least one damper foot.

18. Holding device according to any of the preceding claims,
characterized in that
the electronic components to be held are fixedly connected to the device carrier.

19. Holding device according to any of the preceding claims,
characterized in that
a capacitive or inductive coupling for connecting two electronic components is provided in the damper foot.
